(19) United States
(12) Patent Application Publication
(10) Pub. No.: US 2019/0128341 A1
(43) Pub. Date: May 2, 2019

(54) CAGE ACTUATION FOR WEDGE CLUTCH

(71) Applicant: SCHAEFFLER TECHNOLOGIES AG & CO. KG, HERZOGENAURACH (DE)

(72) Inventors: Carsten OHR, Charlotte, NC (US); Ryan CARLINO, Charlotte, NC (US)

(21) Appl. No.: 15/795,490

(22) Filed: Oct. 27, 2017

(51) Int. Cl. F16D 41/063

(52) U.S. Cl. CPC F16D 41/063; F16D 15/00

(57) ABSTRACT

A wedge clutch includes an inner race, such as a hub, and an outer race, such as a carrier. Torque can be selectively transferred between the inner and outer races. The wedge clutch includes a plurality of wedge segments arranged about a central axis, circumferentially separated from each other, and collectively forming an annular wedge plate disposed between the inner and outer races. An actuating cage is coupled to the wedge plate and axially moveable relative to the wedge plate. The actuating cage includes projections that extend at an angle different from and relative to the central axis. To lock the wedge clutch, the actuating cage is moved axially, causing the projections to press between the wedge plate segments. This causes the wedge plate segments to expand radially, engaging with the outer race and transferring torque from the hub to the outer race.

### TECHNICAL FIELD

The present disclosure relates to a wedge clutch for selectively coupling two or more powertrain components to each other.

### BACKGROUND

In a motor vehicle, a four-wheel drive system or an all-wheel drive system can be selectively activated by a clutch. The clutch can be part of a power transfer unit for connecting a power source to a secondary drive shaft when it is desired to deliver power to the secondary drive shaft. It is known that such a clutch can be a dog clutch. Dog clutches are prone to teeth clash or blocking. It is also known that such a clutch can be a wet clutch in a differential. Pressurized fluid must be continuously supplied to keep the clutches in a closed mode, adding to the power usage associated with usage of the clutch.

Recently, wedge clutches are being developed as an alternative structure for coupling an input shaft to an output shaft. Wedge clutches are known, such as those described in U.S. Patent Publication Numbers 2015/0083539, 2015/0014113, and 2015/0152921. A wedge clutch may include an inner race connected to one of the shafts, and an outer race connected to the other of the shafts. A wedge plate is radially disposed between the inner and outer races and is configured to engage the inner and outer races when the clutch is locked to transmit power from the input shaft to the output shaft.

### SUMMARY

According to one embodiment, a wedge clutch includes an inner race rotatable about an axis, and an outer race concentric with the inner race and rotatable about the axis. A plurality of wedge segments are arranged about the axis, are circumferentially separated from each other, and collectively form an annular wedge plate disposed between the inner and outer races. An actuating cage is coupled to the wedge plate and is axially moveable relative to the wedge plate. Axial movement of the actuating cage causes radial expansion and contraction of the wedge segments to selectively transfer torque between the inner race and the outer race.

In another embodiment, a wedge clutch includes a hub extending along an axis, and a wedge plate having a plurality of wedge plate segments concentric with the hub and disposed radially outward of the hub. The wedge plate segments each have an outer surface. A carrier is concentric with the hub, extends along the axis, and is disposed radially outward of the wedge plate. The carrier has an inner surface facing the outer surfaces of the wedge plate segments. An actuating cage has a plurality of projections, each projection extending between two of the wedge plate segments. Axial movement of the actuating cage along the axis relative to the wedge plate selectively locks and unlocks the wedge clutch.

In yet another embodiment, a wedge clutch includes an inner race, an outer race, and a wedge plate located radially between the inner race and the outer race. An actuating cage has a plurality of projections extending through the wedge plate. Axial movement of the actuating cage causes radial expansion and contraction of the actuating cage to selectively engage and disengage the outer race and the inner race.

### BRIEF DESCRIPTION OF THE DRAWINGS

FIG. 1 is a cross-sectional view of a power-transfer unit incorporating a wedge clutch, according to one embodiment.

FIG. 2 is a perspective view of a wedge plate having multiple wedge segments.

FIG. 3A is a cross-sectional view of a wedge clutch with an actuating cage in a disengaged state, according to one embodiment.

FIG. 3B shows the wedge clutch of FIG. 3A in an engaged state, according to one embodiment.

FIG. 4 is a front view of the actuating cage, according to one embodiment.

FIG. 5 is a partial side view of the actuating cage, according to one embodiment.

FIG. 6 is a front view of two wedge segments of the wedge plate with a portion of the actuating cage therebetween, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

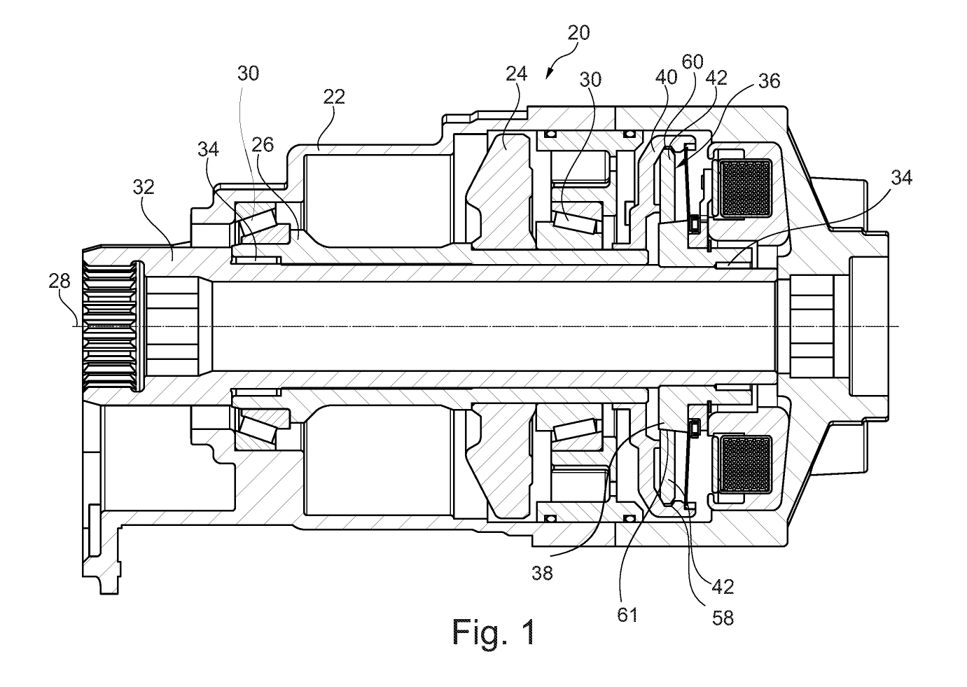

FIG. 1 discloses a power-transfer unit (PTU) 20 for a powertrain of a vehicle, with the PTU implementing one example of a wedge clutch, as disclosed in U.S. patent application Ser. No. 15/388,270, which is hereby incorporated by reference in its entirety. The PTU may be for an all-wheel-drive motor vehicle such as a passenger car or truck. In that example, the PTU 20 includes a housing 22 that supports an input shaft 26 for rotation about an axis 28 via bearings 30. A gear 24 may be fixed to the input shaft 26 by a spline connection. The gear 24 may be driveably connected to a transmission output shaft. Two components are driveably connected if they are connected by a power flow path that constrains their rotational speeds to be directly proportional. An output shaft 32 is disposed in the housing 22 and is supported for rotation about the axis 28 via bearings 34.

In the example shown in FIG. 1, a wedge clutch 36 is disposed in the housing 22 and selectively couples the input shaft 26 to the output shaft 32 to transfer torque from the input shaft 26 to the output shaft 32. The clutch 36 has a closed state (also referred to as a locked state) in which the input and output shafts are coupled to each other and an open state (also referred to as an unlocked state) in which the input and output shafts are independently rotatable relative to each other. The wedge clutch 36 may include a hub 38 (which may be referred to as an inner race), a carrier 40 (which may be referred to as an outer race), and a disk 42 (which may be referred to as a wedge plate) that are all supported for rotation about the axis 28.

An outer edge 60 of the wedge plate 42 is disposed in a groove 58 of the carrier 40, and an inner edge 61 of the wedge plate is disposed on the hub 38. When the wedge clutch 36 is locked, the outer edge 60 frictionally engages with the groove 58, and the inner edge 61 engages with the hub 38 (which is a ramped surface in this example) to couple the carrier 40 to the hub 38, creating a power flow path between the input shaft 26 and the output shaft 32.

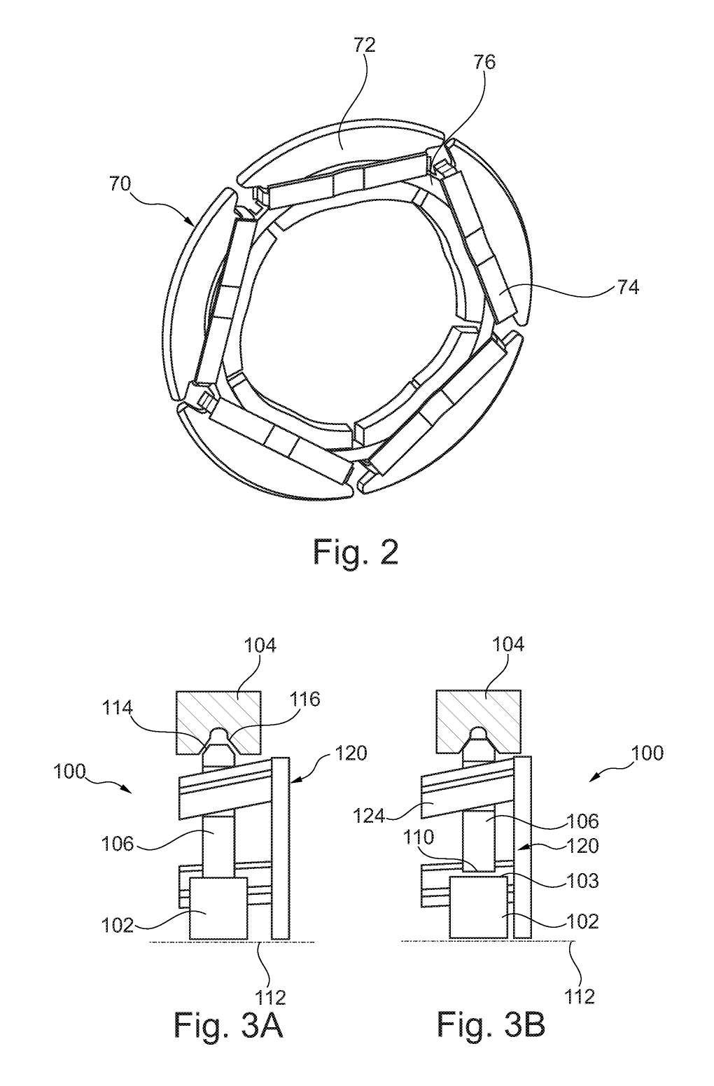

The wedge plate may include a plurality of wedge segments retained together by springs and biased to the disengaged position. For example, FIG. 2 shows one embodiment of a wedge plate 70 having a plurality of wedge plate segments, or wedge segments 72. The wedge segments are bound together via a snap ring that is secured on the wedge segments via a plurality of retaining springs 74. A snap ring 76 holds the segments radially inward. This biases the wedge segments 72 to their disengaged position, disengaged from the outer race.

The use of retaining springs and snap rings increases costs of manufacture and assembly. It is therefore desirable to have a wedge clutch with radially-expanding wedge segments while reducing production costs, assembly costs, and weight.

Therefore, according to various embodiments of this disclosure, a wedge clutch is provided with an actuating cage that moves relative to the wedge segments to radially displace the wedge segments. The actuating clutch may hold or bind the wedge segments together, or may not hold the wedge segments together. As will be described below, the actuating cage can move axially to thereby radially displace the wedge segments to engage and disengage the wedge clutch.

One example of such a wedge clutch is shown in FIGS. 3A-6. FIG. 3A shows a wedge clutch 100 in a disengaged state, and FIG. 3B shows the clutch 100 in an engaged state. Similar to the description of FIG. 1, the wedge clutch 100 includes an inner race or hub 102, and an outer race or carrier 104. A wedge plate 106 is disposed radially between the inner and outer races. The wedge plate 106 includes a plurality of wedge segments 108, two of which are shown in FIG. 6. In one embodiment, five wedge segments are provided. Each wedge segment 108 includes an inner surface 110 facing the central axis 112 of the wedge clutch, and an outer surface 114 radially outward from the inner surface. In one embodiment, the hub 102 does not have a circular cross-sectional profile; instead, an outer surface 103 of the hub 102 may have a plurality of ramped surfaces including cams that ramp radially outward from the center of the hub 102. The wedge segments 108 may have corresponding cam surfaces on the inner surface 110 that cooperate with the cams on the outer surface 103 of the hub 102 to force the wedge segments 108 radially outward to engage the outer surfaces 114 with the carrier 104. The carrier 104 is provided with corresponding inner surfaces 116 that are tapered to receive the tapered surfaces of the outer surfaces 114 of the wedge segments 108.

In the disengaged state shown in FIG. 3A, the outer surfaces 114 of the wedge segments 108 are spaced from the inner surface 116 of the carrier 104. Torque is therefore not transmitted from the hub 102 to the carrier 104, and the clutch is unlocked or disengaged. In the engaged state shown in FIG. 3B, the wedge segments 108 are expanded radially outward, causing the outer surfaces 114 of the wedge plate to engage with the inner surface 116 of the carrier. Torque is therefore transmitted from the hub 102 to the carrier 104, and the clutch is locked or engaged.

The wedge clutch 100 also includes an actuating cage 120. The actuating cage 120 is able to translate linearly along the axis 112, as shown in FIGS. 3A and 3B. The actuating cage 120 is configured to radially expand the wedge segments 108. In one embodiment, the actuating cage 120 includes a plate 122 (also referred to as a base or ring) that is annular in shape and centered about the axis 112. Extending from the plate 122 are a plurality of projections 124 (also referred to as bars, beams, or arms).

As can be seen in FIG. 6, each of the projections 124 are fitted between two adjacent wedge plate segments 108. In one embodiment, the wedge segments 108 have corresponding cut-outs 130 or voids at their ends (with respect to the circumferential direction). The cut-outs 130 of two adjacent wedge plates 108 cooperate to define an aperture configured to receive a single projection 124. The projections 124 therefore separate the individual wedge segments 108 but contain them together to maintain their configuration as a single wedge plate 106.

In one embodiment, the projections 124 have eight sides. The two largest of the sides are in contacting engagement with the radially-inward portion of the cut-outs 130. The next two largest of the sides are in contacting engagement with the radially-outward portion of the cut-outs 130. The remaining sides do not contact the cut-outs directly, but remain substantially separated from the cut-out surfaces to facilitate relative movement between the projections 124 and the plate 122.

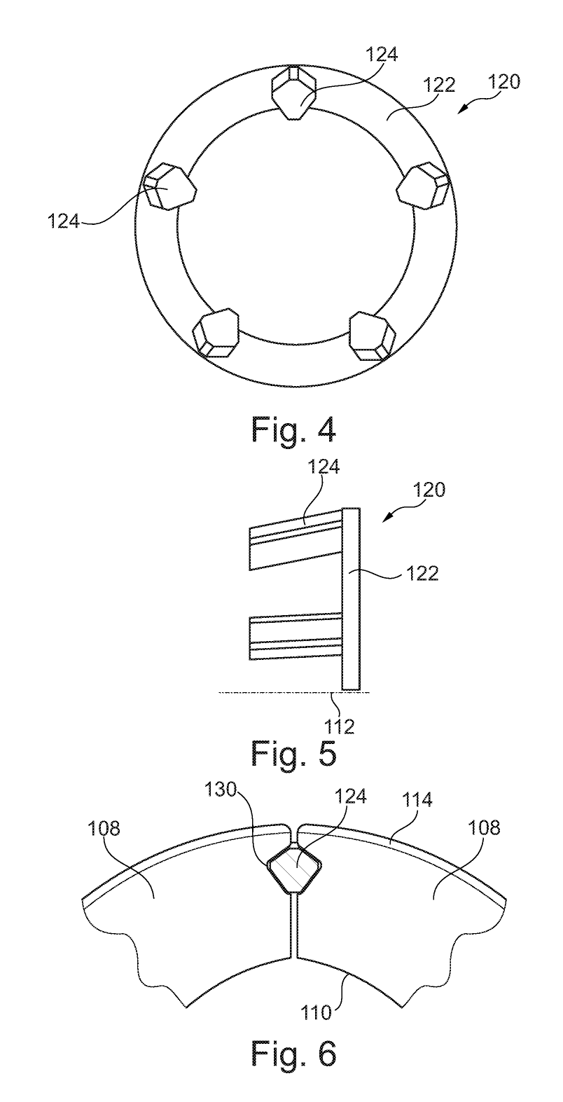

As can be seen in FIGS. 3A-4, the projections 124 extend from the plate 122 and radially inward toward the axis 112. When the actuating cage 120 moves linearly along the axis (via an actuating power source, not shown), the inward angle or slope of the projections 124 relative to the axis 112 causes the wedge plate segments 108 to expand and contract into the engaged position and disengaged position, respectively. This is shown in FIGS. 3A and 3B, for example, in which the actuating cage 120 is at a first linear position in FIG. 3A when the wedge clutch is disengaged, and the actuating cage 120 is at a second linear position in FIG. 3B relative to the wedge plate 106, causing the wedge segments of the wedge plate 106 to expand and engage the carrier 104. When the actuating cage 120 is moved linearly, the projections 124 slide through the openings between adjacent wedge segments 108. As the projections 124 slide relative to the wedge plates segments 108 (e.g., to the left in the view taken in FIGS. 3A-3B), the wedge segments 108 expand radially outward to engage with the carrier 104 and lock the clutch.

It should be understood that the actuating cage 120 shown in the figures is merely one embodiment. Other designs can be utilized while still maintaining the function of sliding relative to the wedge plate segments to expand or contract them. For example, in one embodiment, the projections of the actuating cage extend radially outward, such that the radial inward and outward movement of the wedge segments is reversed relative to the directional movement of the actuating cage shown in FIG. 3A-3B. That embodiment may be beneficial in an embodiment in which the carrier is located radially inward of the wedge plate, and the hub is located radially outward of the wedge plate such that the wedge clutch is engaged with inward radial movement, or contraction, of the wedge segments.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A wedge clutch comprising:
an inner race rotatable about an axis;
an outer race concentric with the inner race and rotatable about the axis;
a plurality of wedge segments arranged about the axis, circumferentially separated from each other, and collectively forming an annular wedge plate disposed between the inner and outer races; and
an actuating cage coupled to the wedge plate and axially moveable relative to the wedge plate, wherein axial movement of the actuating cage causes radial expansion and contraction of the wedge segments to selectively transfer torque between the inner race and the outer race.

2. The wedge clutch of claim 1, wherein the actuating cage includes a plurality of projections that extend through the wedge plate.

3. The wedge clutch of claim 2, wherein each projection extends through a gap between two adjacent wedge segments of the wedge plate.

4. The wedge clutch of claim 2, wherein the projections extend in a direction non-parallel to the axis, and the axial movement of the actuating cage slides the wedge segments along the projections to radially expand and contract.

5. The wedge clutch of claim 4, wherein the projections extend inward toward the axis.

6. A wedge clutch comprising:
a hub extending along an axis;
a wedge plate having a plurality of wedge plate segments concentric with the hub and disposed radially outward of the hub, the wedge plate segments each having an outer surface;
a carrier concentric with the hub, extending along the axis, and disposed radially outward of the wedge plate, the carrier having an inner surface facing the outer surfaces of the wedge plate segments; and
an actuating cage having a plurality of projections, each projection extending between two of the wedge plate segments, wherein axial movement of the actuating cage along the axis relative to the wedge plate selectively locks and unlocks the wedge clutch.

7. The wedge clutch of claim 6, wherein the projections extend in a direction angularly offset from the axis.

8. The wedge clutch of claim 7, wherein the projections extend inward toward the axis.

9. The wedge clutch of claim 7, wherein the axial movement of the actuating cage in one axial direction expands the wedge plate segments such that the outer surfaces engage the inner surface, and axial movement of the actuating cage in another axial direction contracts the wedge plate segments such that the outer surfaces disengage from the inner surface.

10. The wedge clutch of claim 9, wherein torque is transferred between the hub and carrier when the outer surfaces are engaged with the inner surface, and torque is not transferred between the hub and carrier when the outer surfaces are disengaged with the inner surface.

11. The wedge clutch of claim 6, wherein each wedge plate segment defines side surfaces circumferentially spaced from each other, each side surface having a cut-out surface sized to receive one of the projections.

12. The wedge clutch of claim 11, wherein each projection is disposed two cut-out surfaces of two adjacent wedge plate segments.

13. A wedge clutch comprising:
an inner race;
an outer race;
a wedge plate located radially between the inner race and outer race; and
an actuating cage having a plurality of projections extending through the wedge plate, wherein axial movement of the actuating cage causes radial expansion and contraction of the actuating cage to selectively engage and disengage the outer race and the inner race.

14. The wedge clutch of claim 13, wherein the outer race and inner race are concentric about a central axis, and the projections have a length extending along an axis that is offset from the central axis.

15. The wedge clutch of claim 13, wherein the wedge plate includes a plurality of wedge plate segments separated from one another.

16. The wedge clutch of claim 15, wherein each projection extends between and connects two of the wedge plate segments.

17. The wedge clutch of claim 16, wherein the axial movement of the actuating cage drives the projections through the wedge plate between the wedge plate segments.

18. The wedge clutch of claim 17, wherein the wedge plate segments cooperate to define a circumference of the wedge plate, and the axial movement of the actuating cage expands the circumference.

19. The wedge clutch of claim 13, wherein the outer race includes a concave inner surface, and the inner race includes a convex outer surface configured to be received within the inner surface when the outer race and the inner race are engaged.
